(19) United States
(12) Patent Application Publication
(10) Pub. No.: US 2006/0067728 A1
(43) Pub. Date: Mar. 30, 2006

(54) Image recording device

(75) Inventors: Katsuya Shimatsu, Ebina-shi (JP); Masatoshi Kimura, Ebina-shi (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/062,921

(22) Filed: Feb. 23, 2005

(30) Foreign Application Priority Data
Sep. 24, 2004 (JP) 2004-278047

(51) Int. Cl. G03G 15/16

(52) U.S. Cl. 399/101

(57) ABSTRACT

An image recording device transfers an image, which is formed on a photoconductor, onto a continuous sheet which is pressed against the photoconductor by a transfer roller. Cleaning of the transfer roller is carried out by applying a bias voltage to the transfer roller to return toner on the transfer roller toward the photoconductor. The cleaning is carried out when the transfer roller is in contact with a non-printing region of a reverse surface of the continuous sheet.

### CROSS-REFERENCE TO RELATED APPLICATION

This application claims priority under 35 USC 119 from Japanese Patent Application No. 2004-278047, the disclosure of which is incorporated by reference herein.

### BACKGROUND OF THE INVENTION

1. Field of the Invention

The present invention relates to an image recording device.

2. Description of the Related Art

A corona transfer system has conventionally been used as the transfer mechanism of a high-speed, continuous sheet printer. However, use of a transfer roller system is desirable as a countermeasure to poor transfer caused by using poor-quality sheets or thin sheets or by wrinkles in the sheets at the time of overlapped printing, and poor transfer of stepped media, and the like.

The transfer roller system is a technique which is generally employed in cut-sheet printers. However, when used in a high-speed, continuous sheet printer, there are several technical problems, among which cleaning of the transfer roller is the most serious.

During transfer, the transfer roller usually contacts a photoconductor, and charges for attracting the toner on the photoconductor are applied to the transfer roller. Therefore, if there are portions of the transfer roller over which a sheet does not pass (in order to handle various sheet widths), the toner on the photoconductor at the portions over which the sheet does not pass moves onto the transfer roller. Thereafter, when a sheet having a wide width passes through, there is the problem that the reverse surface of the sheet will be contaminated by the toner which has moved onto the transfer roller.

Due to requirements to reduce costs and to simplify mechanisms as devices become more compact, cleaning of the conventional transfer roller is carried out in which, in the state in which the transfer roller contacts the photoconductor at a time when printing is not being carried out (between sheets in the case of cut sheets), bias of the reverse polarity of the transfer bias is applied to the transfer roller, such that the toner on the transfer roller is returned to the photoconductor(see, for example, FIG. 2 and pages 5 through 7 of Japanese Patent Application Laid-Open (JP-A) No. 7-281492).

Namely, with reference to FIG. 7, by switching a usual bias 204 to a reverse bias 206, the potential of a transfer roller 202 is switched, and the toner, which has adhered to the transfer roller 202 from a photoconductor 200, is returned to the photoconductor 200 and is recovered at a drum cleaner 208.

In the above-described method, the cleaning ability is good because the cleaning is carried out immediately after the transfer roller is contaminated by the toner. However, when a similar method is employed in the case of a continuous sheet, because cleaning cannot be carried out between sheets, the amount of contamination of the transfer roller (the amount of toner) is great, the amount of the contaminating toner which moves to the transfer roller is great, and there are cases in which cleaning cannot be carried out completely. Accordingly, further improvement in the cleaning efficiency is required.

A method has also been conceived of in which the transfer roller and the drum are repeatedly made to contact with each other so as to apply impact and knock off the toner. However, control of the position of contact is necessary, and a long time is needed for the cleaning (the entire outer periphery of the transfer roller must be made to contact the drum, and control of the position at the width of the nip is necessary). Therefore, a method of improving the cleaning efficiency with a simpler configuration is desired.

### SUMMARY OF THE INVENTION

In view of the aforementioned, the present invention provides an image recording device in which, when a continuous sheet is used, there is little contamination of the reverse surface thereof.

An aspect of the present invention is an image recording device transferring an image, which is formed on a photoconductor, onto a continuous sheet which is pressed against the photoconductor by a transfer roller, wherein cleaning is carried out in which bias voltage is applied to the transfer roller and toner on the transfer roller is returned toward the photoconductor, and the cleaning is carried out when the transfer roller is contacting a non-printing region of a reverse surface of the continuous sheet.

In the invention of the above-described aspect, at the time of cleaning in which residual toner is reversely transferred from the transfer roller side toward the photoconductor by using the continuous sheet, the reverse transfer is carried out at a non-printing region such as between pages or between jobs or the like. It is thereby possible to realize an image recording device in which the printing quality is not affected and there is no contamination of the reverse surface.

### BRIEF DESCRIPTION OF THE DRAWINGS

FIG. 1 is a perspective view showing an image recording device relating to a first embodiment of the present invention.

FIG. 2 is a side view showing the image recording device relating to the first embodiment of the present invention.

FIG. 3A is a perspective view showing operation of the image recording device relating to the first embodiment of the present invention.

FIG. 3B is a perspective view showing the operation of the image recording device relating to the first embodiment of the present invention.

FIG. 4 is a side view showing a transfer portion of the image recording device relating to the first embodiment of the present invention.

FIG. 5 is a drawing showing printing regions of the image recording device relating to the first embodiment of the present invention.

FIG. 6 is a timing chart showing the operation of the image recording device relating to the first embodiment of the present invention.

FIG. 7 is a side view showing a transfer portion of a conventional image recording device.

### DETAILED DESCRIPTION OF THE INVENTION

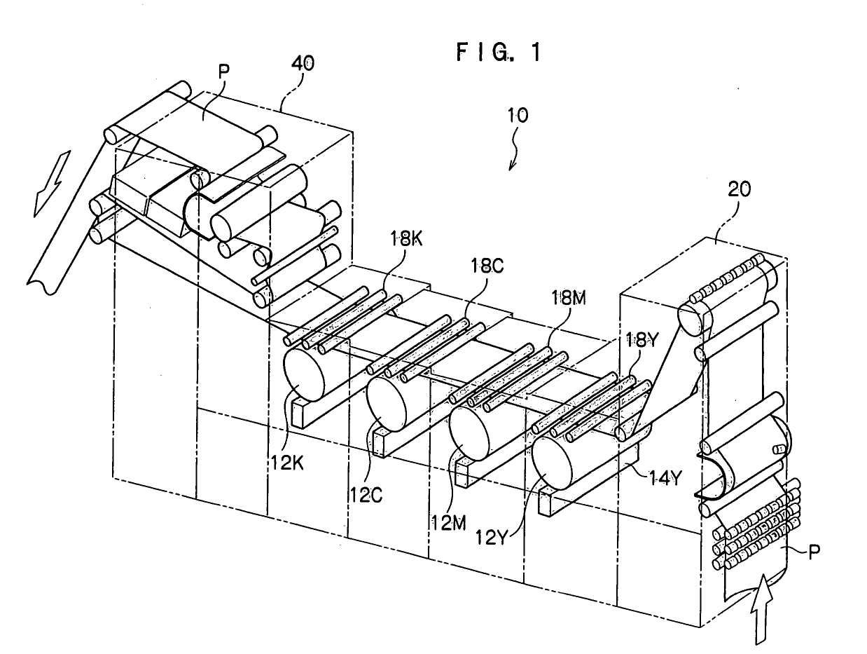

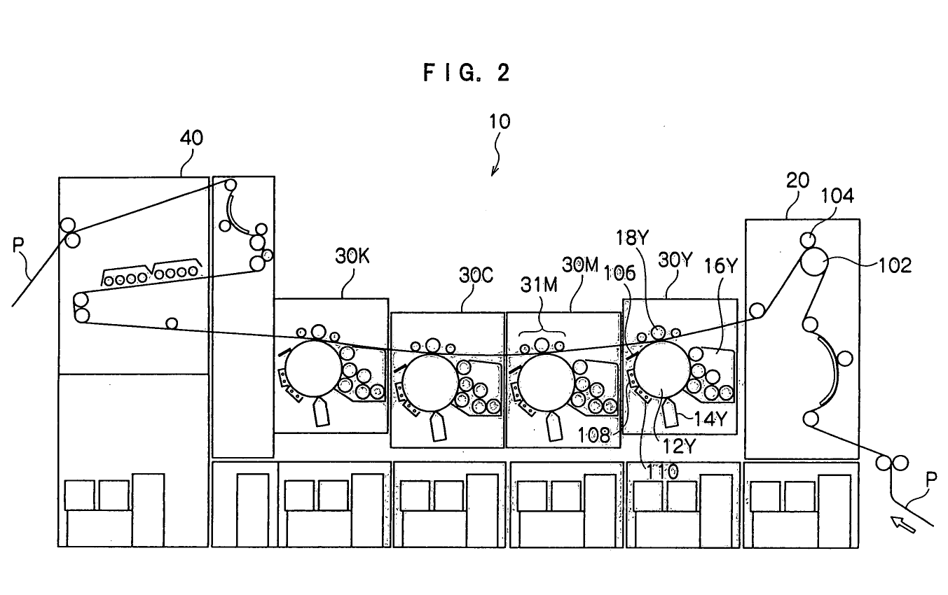

An image recording device relating to a first embodiment of the present invention is shown in FIGS. 1 and 2.

As shown in FIGS. 1 and 2, printing sections 30Y, 30M, 30C, 30K are disposed in that order from a conveying direction upstream side in a color laser printer (hereinafter, “printer”) 10 which serves as the image recording device. The printing sections 30Y, 30M, 30C, 30K transfer toner images of the colors of yellow (Y), magenta (M), cyan (C), and black (K) onto a continuous sheet P such that the respective toner images are superposed one on the other.

A sheet conveying section 20, which conveys the entrained continuous sheet P at the printing sections 30Y through 30K, is provided at the conveying direction upstream side of the printing sections 30Y through 30K. A fixing section 40, which fixes to the continuous sheet P the unfixed toner images which have been transferred by the printing sections 30Y through 30K, is provided at the conveying direction downstream side of the printing sections 30Y through 30K.

The sheet conveying section 20 has a conveying roller 102 around which the continuous sheet P is entrained. An idle roller 104 abuts the conveying roller 102, and conveys the continuous sheet P with the continuous sheet P being nipped at a nip portion between the conveying roller 102 and the idle roller 104. The both axial direction end portions of the conveying roller 102 are rotatably supported at the sheet conveying frame 20 via unillustrated bearings.

Each of the printing sections 30Y through 30K has a photoconductor 12. A transfer roller 18, a cleaning device 106, a discharger 108, a charger 110, an LED head 14, and a developing unit 16 are provided around the photoconductor 12 in that order along the direction of rotation of the photoconductor 12 (the counterclockwise direction in the drawing).

The transfer roller 18 has guide rollers 22 at the conveying direction front and back sides thereof, and forms a transfer portion 31. The transfer roller 18 serving as the transfer portion abuts the top surface of the photoconductor 12, and, together with the photoconductor 12, nips and conveys the continuous sheet P which is supported by the guide rollers 22.

In accordance with a write signal from an unillustrated control section, the LED head 14 carries out image-writing on the outer peripheral surface of the photoconductor 12 which is charged by the charger 110. In this way, the charges of the exposed portions are lost such that an electrostatic latent image is formed on the outer peripheral surface of the photoconductor 12. Toner is supplied from the developing unit 16 to the outer peripheral surface of the photoconductor 12, and a toner image is formed thereon.

Due to the toner images being transferred onto the continuous sheet P which is nipped by the photoconductors 12 and the transfer rollers 18, a toner image is formed on the continuous sheet P. The continuous sheet P onto which the toner image has been transferred is conveyed to the fixing section 40. The toner image on the surface is fixed and becomes an output image.

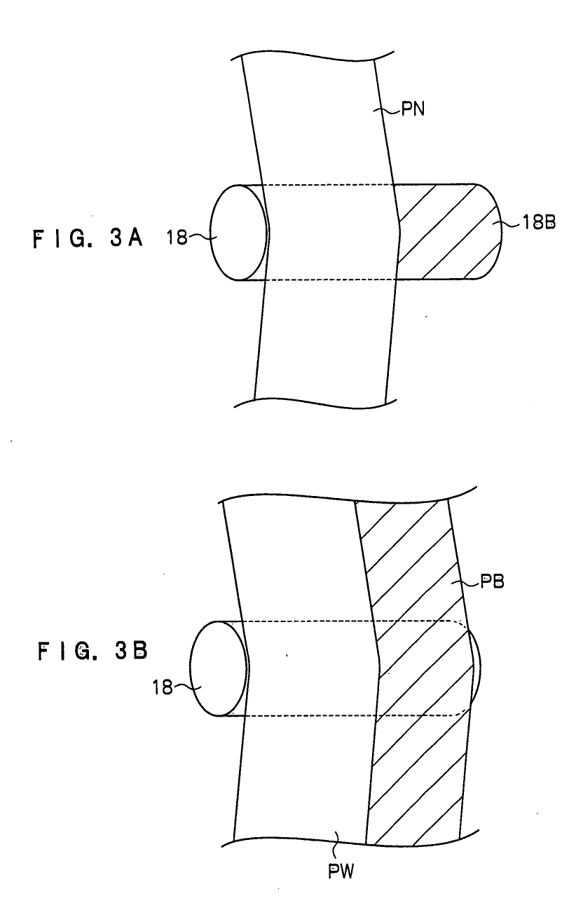

As shown in FIG. 3A, when large-scale printing processing is carried out continuously on the continuous sheet P, residual toner accumulates on the transfer roller 18. Namely, during transfer, the transfer roller 18 always contacts the photoconductor 12, and charges for attracting the toner on the photoconductor 12 are applied to the transfer roller 18. Therefore, if a narrow continuous sheet PN is used, the problem arises that the toner on the photoconductor 12 at the portion where there is no continuous sheet P, moves to a portion (18B) on the transfer roller 18 where there is no continuous sheet P.

Thereafter, if the continuous sheet PN is replaced by the continuous sheet PW having a wide width, the problem arises that a reverse surface PB of the continuous sheet P which is contacting the portion of the transfer roller 18 contaminated by the toner, i.e., 18B, is contaminated by the toner on the transfer roller 18.

Therefore, conventionally, cleaning has been carried out in which, in the state in which the transfer roller 18 contacts the photoconductor 12, bias of the reverse polarity as the toner is applied to the transfer roller 18, and the residual toner on the transfer roller 18 is returned to the photoconductor 12.

In this method, because cleaning is carried out immediate after the transfer roller 18 is contaminated, the cleaning ability is good. However, when the same method is applied to the continuous sheet P, cleaning cannot be carried out between sheets because there is no space between sheets.

Namely, even if bias of the reverse polarity is applied to the transfer roller 18, because there are no gaps between sheets at the continuous sheet P, the residual toner ultimately moves onto the reverse surface of the continuous sheet P, which is a cause of contamination of the reverse surface. Thus, in the present invention, cleaning of the transfer roller 18 is carried out between pages or between jobs.

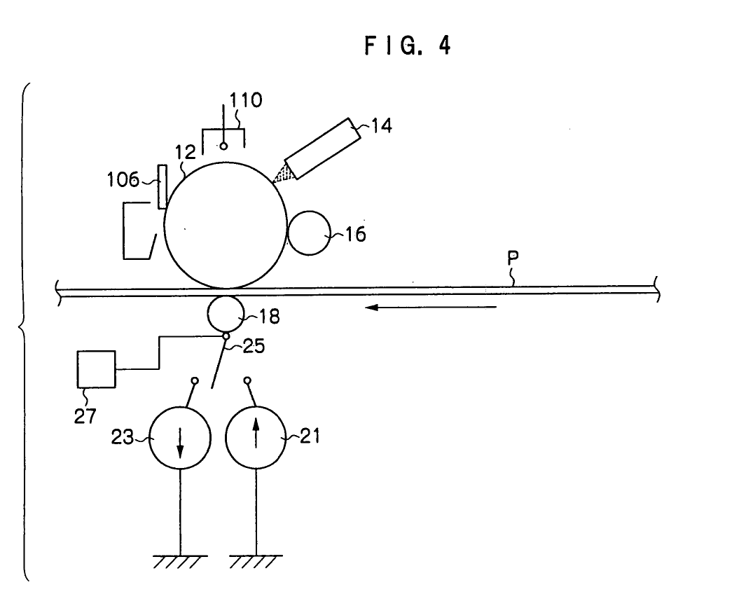

A transfer portion relating to the first embodiment of the present invention is shown in FIG. 4.

As shown in FIG. 4, the surface of the photoconductor 12 is charged uniformly by the charger 110. Due to exposure being carried out by the LED head 14, the charges of the exposed portions are lost. The toner supplied from the developing unit 16 adheres to the unexposed portions, such that a toner image is formed.

The toner image formed on the photoconductor 12 is transferred onto the continuous sheet P which is nipped between the photoconductor 12 and the transfer roller 18. The continuous sheet P is conveyed to the fixing section 40, and is output after the toner image is fixed. The transfer roller 18 is connected by a switching portion 25 to one of a regular transfer bias power source 21 and a reverse transfer bias power source 23, and voltage is applied. At times of the printing operation and at times of cleaning, the switching portion 25, in accordance with a signal from a control unit 27, switches the regular transfer bias power source 21 and the reverse transfer bias power source 23 which is connected to the transfer roller 18.

At the time of transfer of the toner image, the transfer roller 18 is connected to the regular transfer bias power source 21, and the potential is in the order of the photoconductor 12—the toner—the transfer roller 18. Therefore, the toner image on the photoconductor 12 moves in the direction of the transfer roller 18, and is transferred onto the continuous sheet P.

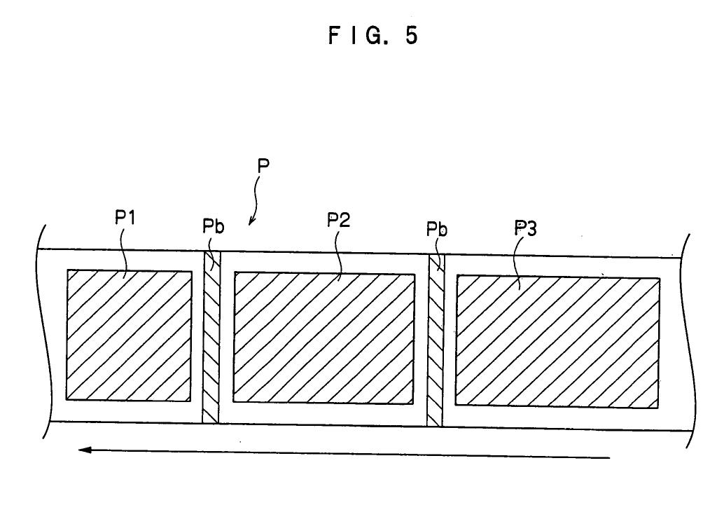

When transfer for one page is completed, in accordance with a signal from the control unit 27, the switching portion 25 connects the transfer roller 18 to the reverse transfer bias power source 23. The residual toner adhering to the transfer roller 18 is, in the midst of moving toward the photoconductor 12, transferred onto the reverse surface of the continuous sheet P, i.e., the reverse surface of the portion which is not used in printing and which corresponds to Pb in FIG. 5 which will be explained later. This residual toner is, without being returned to the photoconductor 12, fixed by the fixing section 40 of FIG. 1, and is output in that state of being transferred on the reverse surface of the continuous sheet P.

As mentioned above, the region to which the residual toner is transferred is portion Pb which is not used in printing in the first place. Therefore, even if this portion is contaminated by the residual toner, the output quality is not affected. In addition, because cleaning is carried out page-by-page, the amount of residual toner each one time is extremely small, and the dirt adhering to the reverse surface of Pb is of an extent such that it does not present problems when viewed. Therefore, it is possible to carry out only cleaning of the transfer roller 18 without substantially affecting the quality.

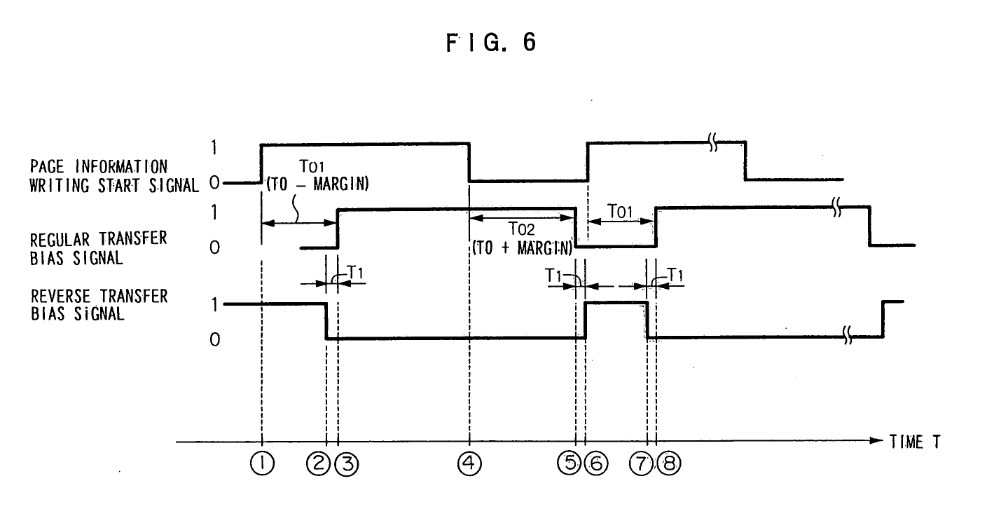

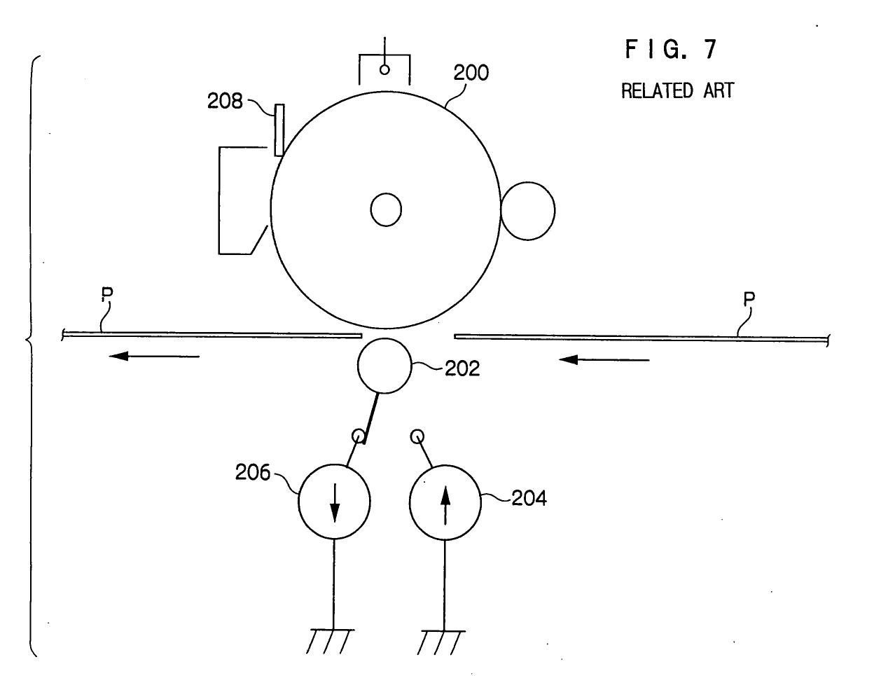

Namely, as shown in FIGS. 5 and 6, after the operation of transfer for one page is completed, before transfer for the next page begins, bias of the reverse polarity is applied to the transfer roller 18. The residual toner of the transfer roller 18 is moved toward the photoconductor 12 at the region between the printing region of the page and the printing region of the next page, so as to clean the transfer roller.

Or, after transfer for one job is completed, before transfer for the next job is started, bias of the reverse polarity is applied to the transfer roller 18. The residual toner of the transfer roller 18 is moved toward the photoconductor 12 at the region between the printing region of the job and the printing region of the next job, so as to clean the transfer roller.

At this time, because the continuous sheet P actually exists between the transfer roller 18 and the photoconductor 12, the residual toner is transferred to a region of the continuous sheet P which region is not used in printing and is between a printing region and the next printing region, or between a job and the next job.

Namely, as shown in FIG. 5, the reverse surfaces of the portions Pb, which are not used in printing and which are between printing regions P1, P2, P3, . . . of the continuous sheet P, are used in cleaning. Because Pb are portions which are not used in printing in the first place, even if Pb are contaminated, the outputted image quality is not affected. In addition, because cleaning is carried out per page, the amount of residual toner each one time is extremely small, and the dirt adhering to the reverse surface of Pb is of an extent such that it does not present problems when viewed.

Or, the portions Pb, which are not used in printing and which exist between jobs, may be used in cleaning. In this case, residual toner of an amount corresponding to the number of printed pages of each one job is transferred onto the reverse surface of Pb. However, there are advantages such as time for switching the bias per page is not needed, and there is leeway of time between jobs, and the like.

FIG. 6 shows a bias signal pattern of the transfer portion relating to the first embodiment of the present invention.

As shown in FIG. 6, when a page information write start signal is sent from a control section to the LED head 14, exposure is carried out at the write position shown by the diagonal lines in FIG. 4, and a latent image is formed on the charged photoconductor 12 (1 enclosed in a circle in FIG. 6). Up until the time that this latent image reaches the nip position between the transfer roller 18 and the photoconductor 12 as the photoconductor 12 rotates, the region of the continuous sheet P contacting the transfer roller 18 is other than the printing region, i.e., is the portion corresponding to Pb in FIG. 5. Therefore, the reverse transfer bias is applied to the transfer roller 18, and the transfer roller 18 is in the cleaning state.

Here, the time for one point on the photoconductor 12 to reach the nip portion between the transfer roller 18 and the photoconductor 12 from the image exposure position by the LED head 14 is T₀, and the time required to switch between the regular transfer bias and the reverse transfer bias is T₁. When the photoconductor 12 rotates and the toner image formed by the toner supplied from the developing unit 16 reaches the transfer portion, i.e., the nip portion between the transfer roller 18 and the photoconductor 12, the regular transfer bias must be applied to the transfer roller 18 in order to make the toner image move from the photoconductor 12 to the transfer roller 18.

Therefore, there is the need for the bias to be switched to the regular transfer bias after time T₀₁ (3 enclosed in a circle in FIG. 6), which is equal to the time T₀, for reaching the nip portion between the transfer roller 18 and the photoconductor 12 from the image exposure position, minus a margin.

The signal for switching from the reverse transfer bias to the regular transfer bias is sent from the control unit 27 to the switching portion 25 at a time (2 enclosed in a circle in FIG. 6) which is earlier by the switching time T₁ for switching from the reverse transfer bias to the regular transfer bias. In this way, at the needed time, the bias applied to the transfer roller 18 is switched from reverse transfer to regular transfer (3 enclosed in a circle in FIG. 6).

When printing of one page is completed and the writing onto the photoconductor 12 by the LED head 14 is completed (4 enclosed in a circle in FIG. 6), after time T₀₂ (5 enclosed in a circle in FIG. 6), which is equal to a margin plus the time T₀ for reaching the nip portion between the transfer roller 18 and the photoconductor 12 from the image exposure position, there is no longer the need to apply the regular transfer bias, and the bias is switched to the reverse transfer bias for the next cleaning.

Therefore, after the switching time T₁, the signal for switching to the reverse transfer bias is sent from the control unit 27 to the switching portion 25 (6 enclosed in a circle in FIG. 6). The reverse transfer bias is applied to the transfer roller 18, and the residual toner moves from the transfer roller 18 toward the photoconductor 12 and is transferred onto the reverse surface of the continuous sheet P between pages.

On the other hand, when writing of the next page by the LED head 14 is started, after T₀₁ (8 enclosed in a circle in FIG. 6), the regular transfer bias must be applied to the transfer roller 18. Therefore, the signal for switching from the reverse transfer bias to the regular transfer bias is sent from the control unit 27 to the switching portion 25 at a time (7 enclosed in a circle in FIG. 6) which is earlier by the switching time T₁. In this way, at the needed time, the bias applied to the transfer roller 18 is switched from reverse transfer to regular transfer. The toner image formed on the photoconductor 12 thereby moves toward the transfer roller 18, and is transferred onto the continuous sheet P.

At portions where the transfer roller 18 and the photoconductor 12 directly contact one another without the continuous sheet P therebetween, the residual toner moves from the transfer roller 18 toward the photoconductor 12, and is recovered at the cleaning device 106. Therefore, for the portions of direct contact as well, cleaning is carried out together with the recording operation. In cases in which the continuous sheet is switched to the continuous sheet P having a wider width, it is possible to prevent the reverse surface thereof from being contaminated.

By repeating these processes thereafter, cleaning of the transfer roller 18 is carried out without affecting the transfer of the toner images. Because the residual toner is reversely transferred onto the reverse surface of the continuous sheet P between the printing regions of the continuous sheet P, contamination of the reverse surface can be prevented without affecting the image quality and without lowering the processing speed.

Contamination of the reverse surface at the time of recording can be prevented even more by, when the continuous sheet P is replaced, transferring the residual toner of the transfer roller 18 onto the reverse surface at the time of conveying the trailing edge of the continuous sheet P before replacement, or at the time of conveying the unnecessary blank portion at which recording is not carried out at the leading edge portion of the continuous sheet P which is newly replaced.

The foregoing description of the embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image recording device transferring an image, which is formed on a photoconductor, onto a continuous sheet which is pressed against the photoconductor by a transfer roller, wherein
cleaning is carried out in which a bias voltage is applied to the transfer roller and toner on the transfer roller is returned toward the photoconductor, and
the cleaning is carried out when the transfer roller is contacting a non-printing region of a reverse surface of the continuous sheet.

2. The image recording device of claim 1, wherein the cleaning is carried out after transfer for a job is completed and before transfer for a next job is started.

3. The image recording device of claim 1, wherein the cleaning is carried out after transfer for a page is completed and before transfer for a next page is started.

4. The image recording device of claim 1, wherein, when the continuous sheet is replaced, the cleaning is carried out at a reverse surface of a portion, where image formation is not carried out, of one of a trailing edge and a leading edge of the continuous sheet.

5. The image recording device of claim 2, wherein, when the continuous sheet is replaced, the cleaning is carried out at a reverse surface of a portion, where image formation is not carried out, of one of a trailing edge and a leading edge of the continuous sheet.

6. The image recording device of claim 3, wherein, when the continuous sheet is replaced, the cleaning is carried out at a reverse surface of a portion, where image formation is not carried out, of one of a trailing edge and a leading edge of the continuous sheet.

7. An image recording device comprising:
a photoconductor;
a charging unit that charges the photoconductor;
an exposure head that exposes the photoconductor and discharges exposed portions of the photoconductor;
a transfer roller which nips a sheet for image recording between the transfer roller and the photoconductor; and
a switching portion that connects the transfer roller to one of a first bias power source and a second bias power source.

8. The image recording device of claim 7, further comprising a control unit, the control unit sending a signal to the switching portion and switching from one of the first bias power source and the second bias power source which is connected to the transfer roller to another of the first bias power source and the second bias power source.

9. The image recording device of claim 7, wherein the first bias power source is a regular transfer bias power source, and the second bias power source is a reverse transfer bias power source.

10. The image recording device of claim 8, wherein the first bias power source is a regular transfer bias power source, and the second bias power source is a reverse transfer bias power source.

11. The image recording device of claim 7, wherein, each time image transfer for one page is completed, the switching portion switches a power source which is connected to the transfer roller from the first bias power source to the second bias power source.

12. The image recording device of claim 9, wherein, each time image transfer for one page is completed, the switching portion switches a power source which is connected to the transfer roller from the first bias power source to the second bias power source.

13. The image recording device of claim 7, wherein, each time transfer for one job is completed, the switching portion switches a power source which is connected to the transfer roller from the first bias power source to the second bias power source.

14. The image recording device of claim 9, wherein, each time transfer for one job is completed, the switching portion switches a power source which is connected to the transfer roller from the first bias power source to the second bias power source.
